(19) United States
(12) Patent Application Publication
(10) Pub. No.: US 2013/0287975 A1
(43) Pub. Date: Oct. 31, 2013

(54) Secondary Sealing Material Composition for Multi-Layered Glass and Multi-Layered Glass Using the Same

(71) Applicant: Kaoru Kawami, Hiratsuka-shi (JP)

(72) Inventor: Kaoru Kawami, Hiratsuka-shi (JP)

(73) Assignee: The Yokahama Rubber Co., LTD., Minato-ku, Tokyo (JP)

(21) Appl. No.: 13/880,006

(22) PCT Filed: Jul. 27, 2012
(86) PCT No.: PCT/JP2012/069102

§ 371 Date: Apr. 17, 2013

(30) Foreign Application Priority Data
Jul. 27, 2011 (JP) 2011-163876

(51) Int. Cl. E06B 3/66; C08K 5/101

(52) U.S. Cl. CPC E06B 3/66; C08K 5/101
USPC 428/34; 524/287

(57) ABSTRACT

A secondary sealing material composition for multi-layered glass includes a modified silicone-based polymer having an acrylic acid-based polymer as a main chain and a benzoic acid ester-based plasticizer.

### TECHNICAL FIELD

The present invention relates to a secondary sealing material composition for multi-layered glass and a multi-layered glass using the same.

### BACKGROUND OF THE INVENTION

Multi-layered glass has excellent thermal insulation and acoustic insulation effects, and such multi-layered glass is formed by bonding together sheets of glass with a certain distance therebetween using spacers. Moreover, with the goal of preventing external air and water from entering the space between the sheets of glass, a primary sealing material is arranged on an inner side of the space between the two sheets of glass. This primary sealing material has polyisobutylene or the like as a major ingredient. Also, a secondary sealing material is provided at the space between the sheets of glass and between spacers in order to seal the joint part of the two sheets of glass and in order to suppress movement of the two sheets of glass. The polymer forming the main skeleton of this secondary sealing material is exemplified by polysulfide-based polymers, polyurethane-based polymers, acrylic polymers, or the like (e.g., see Japanese Unexamined Patent Application Publication No. 2008-285582A, Japanese Unexamined Patent Application Publication No. 2008-297473A or Japanese Unexamined Patent Application Publication No. 2010-59006).

The plasticizer included in the sealing material composition of the secondary sealing material is exemplified by butyl benzyl phthalate in the case of a polysulfide-based sealing material composition, and is exemplified by a phthalate plasticizer such as diisononyl phthalate in the case of a polyurethane-based sealing material composition or acrylic sealing material composition.

The external environmental factors that further the deterioration of the primary and secondary sealing materials used for multi-layered glass are exemplified by heat, water, humidity, or the like. Specifically, there have been problems in that due to the accumulation of water in the groove of the rail formed at the window frame, warming of such water by sunlight, and attachment of such warmed water to the secondary sealing material so that moisture is absorbed, the secondary sealing material deteriorates, tensile strength of the secondary sealing material declines, the secondary sealing material expands, and the like.

Since the primary sealing material is readily broken by movement of the multi-layered glass, the deteriorated secondary sealing material becomes unable to sufficiently prevent the movement of glass sheets that results from temperature change-induced expansion and contraction of air within the multi-layered glass, and the primary sealing material is sometimes broken. When the primary sealing material has been broken, external air and water enter through the gaps of the broken primary sealing material, and condensation occurs between the sheets of multi-layered glass.

### SUMMARY

In order to decrease breakage of the primary sealing material, which is readily broken by movement of the multi-layered glass, a secondary sealing material is desired that has little lowering of modulus when exposed to external environmental factors such as heat, water, humidity, or the like, and that has high durability so as to be able to stably restrain the glass sheets.

The present invention provides a secondary sealing material composition for multi-layered glass, and a multi-layered glass using such, where the secondary sealing material composition has little lowering of modulus when exposed to the external environmental factors and has high durability when used as a sealing material for multi-layered glass.

The present invention is described in the following (1) to (3).

(1) A secondary sealing material composition for multi-layered glass including: a modified silicone-based polymer having an acrylic ester-based polymer as a main chain; and

a benzoic acid ester-based plasticizer.

(2) The secondary sealing material composition for multi-layered glass described in (1) above, where content of the benzoic ester-based plasticizer in the composition is not less than 5 mass % and not more than 30 mass %.

(3) A multi-layered glass using as a secondary sealing material the secondary sealing material composition for multi-layered glass described in (1) or (2) above.

According to the present invention, the external environment-induced lowering of modulus may be decreased, and it is possible for a sealing material for multi-layered glass to have high durability.

### BRIEF DESCRIPTION OF THE DRAWING

FIG. 1 is a cross-sectional view schematically illustrating an example of a configuration of a multi-layered glass of this embodiment.

### DETAILED DESCRIPTION

The present invention is explained in detail below. However, the present invention is not limited by the embodiments of the invention (hereinafter referred to as the “embodiments”) described hereinafter. Furthermore, the constituents described in the embodiments include constituents that could be easily conceived by a person skilled in the art and constituents that are essentially identical, or, in other words, are equivalent in scope. Moreover, the constituents described in the embodiments can be combined as desired.

A secondary sealing material composition for multi-layered glass (referred to hereinafter as the “composition of this embodiment”) according to this embodiment is characterized as including a modified silicone-based polymer having an acrylic ester-based polymer as a main chain, and a benzoic acid ester-based plasticizer.

### <Modified Silicone-Based Polymer>

The modified silicone-based polymer is a polymer that includes a hydrolyzable silyl group. The modified silicone-based polymer has the property of curing by crosslinking by formation of siloxane bonds due to hydroxy groups and/or hydrolyzable groups bonded to the silicon atoms. The modified silicone-based polymer has the main chain formed by a polyether polymer, polyester polymer, ether/ester block copolymer, ethylenically unsaturated compound polymer, or diene-based compound polymer. The hydrolyzable silyl group may be bonded to a side chain or to the terminus of this type of main chain.

The polyether polymer is exemplified by polymers having repeat units formed by ethylene oxide, propylene oxide, butylene oxide, polyphenylene oxide, or the like. The polyester polymer is exemplified by polymers having repeat units formed by carboxylic acids such as acetic acid, propanoic acid, maleic acid, phthalic acid, citric acid, pyruvic acid, and lactic acid, and carboxylic acid anhydrides, intramolecular and/or intermolecular esters of such, and substitution products of such. The ether/ester block copolymer is exemplified by copolymers having as repeat units both the aforementioned repeat units of the polyether polymer and the aforementioned repeat units of the polyester polymer.

The ethylenically unsaturated compound polymer and diene-based compound polymer are exemplified by homopolymers such as ethylene, propylene, acrylic acid esters, methacrylic acid esters, vinyl acetate, acrylonitrile, styrene, isobutylene, butadiene, isoprene, chloroprene, or the like, copolymers of two or more types of such monomers, or the like. More specific examples of the ethylenically unsaturated compound polymer and diene-based compound polymer include polybutadiene, styrene-butadiene copolymer, acrylonitrile-butadiene copolymer, ethylene-butadiene copolymer, ethylene-propylene copolymer, ethylene-vinyl acetate copolymer, ethylene-acrylic acid ester copolymer, polyisoprene, styrene-isoprene copolymer, isobutylene-isoprene copolymer, polychloroprene, styrene-chloroprene copolymer, acrylonitrile-chloroprene copolymer, polyisobutylene, polyacrylic acid ester, and polymethacrylic acid ester.

In this embodiment, an acrylic acid ester-based homopolymer, or a copolymer of two or more types of acrylic acid ester-based and non-acrylic acid ester-based monomers, or the like is used as the main chain. The acrylic acid ester-based homopolymer, or a copolymer of two or more types of acrylic acid ester-based and non-acrylic acid ester-based monomers, may be used alone or as a mixture of two or more types as the modified silicone-based polymer.

No particular limitation is placed on the hydrolyzable silyl group included in the modified silicone-based polymer as long as it is a silicon atom-containing group having a hydrolyzable group directly bonded to the silicon atom, or a silanol group bonded to the silicon atom. The hydrolyzable silyl group is capable of causing a condensation reaction (e.g. dehydration reaction or the like) due to use of a condensation catalyst in the presence of moisture, a crosslinking agent, or the like. The hydrolyzable group is exemplified by a halogen atom, alkoxy group, acyloxy group, ketoxime group, amino group, amide group, acid amide group, aminooxy group, mercapto group, and alkenyloxy group. Of these, alkoxy groups are preferable. Examples of the alkoxy group include methoxy groups, ethoxy groups, propoxy groups and butoxy groups.

No particular limitation is placed on the method of production of the modified silicone-based polymer. For example, production is possible by previously known methods such as those described in Japanese Examined Patent Application Publication No. S61-18569. Moreover, commercial products are exemplified by Kaneka Corp. products (MS Polymer S-203, MS Polymer S-303, MS Polymer S-903, MS Polymer S-911, Silyl Polymer SAT 200, Silyl Polymer MA 430, and Silyl Polymer MAX 447), Asahi Glass Co., Ltd. products (EXCESTAR ESS-3620, EXCESTAR ESS-3430, EXCESTAR ESS-2420, and EXCESTAR ESS-2410), or the like.

No particular limitation is placed on molecular weight of the modified silicone-based polymer. However, from the standpoints of viscosity and processability, number average molecular weight (Mn) is preferably from 1,000 to 30,000, and more preferably is from 3,000 to 15,000. When molecular weight of the modified silicone-based polymer is within this range, viscosity becomes appropriate and handling becomes easy for the secondary sealing material composition for multi-layered glass. Note that, in this embodiment, number average molecular weight is measured by the gel permeation chromatography method (GPC).

### <Benzoic Acid Ester-Based Plasticizer>

The benzoic acid ester-based plasticizer is exemplified by benzoic acid esters of ethylene glycol, diethylene glycol, triethylene glycol, tetraethylene glycol, propylene glycol, dipropylene glycol, tripropylene glycol, tetrapropylene glycol, and 2,2,4-trimethyl-1,3-pentanediol; dibenzoic acid esters of polyethylene glycol, propylene glycol, dipropylene glycol, tripropylene glycol, 1,3-butanediol, 1,4-butanediol, 1,6-hexanediol, 3-methyl-1,5-pentanediol, and 1,8-octanediol; neopentyl glycol esters of hydroxypivalic acid; and mixtures of such. EB-400 (produced by Sanyo Chemical Industries, Ltd.) or the like is cited as a specific example of the benzoic acid ester-based plasticizer.

In this embodiment, the benzoic acid ester shown below in General Formula (1) is suitable for use as the benzoic acid ester-based plasticizer. The sealing material composition of this embodiment includes the benzoic acid ester-based plasticizer. Thus, when the sealing material composition of this embodiment is used as a sealing material, it is possible to suppress the permeation of high temperature water into the sealing material, and it is thus possible to suppress the lowering of elastic modulus of the sealing material.

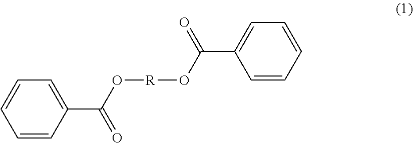

Within the above General Formula (1), R indicates an organic group, and preferably indicates a hydrocarbon group having 1 to 20 carbon atoms.

From the standpoint of improvement of processability of the sealing material and physical properties of the sealing material such as maximum tensile stress or the like, the preferred content of the benzoic acid ester-based plasticizer in the composition is greater than or equal to 5 mass % and less than or equal to 30 mass %, more preferably is greater than or equal to 15 mass % and less than or equal to 25 mass %, and yet further preferably is greater than or equal to 19 mass % and less than or equal to 22 mass %. When the content of the benzoic acid ester-based plasticizer is greater than or equal to 5 mass %, it is possible to obtain a sealing material that has sufficient processability and elongation ratio. When the content of the benzoic acid ester-based plasticizer is less than or equal to 30 mass %, it is possible to obtain an adequate value of maximum stress after initial curing of the sealing material.

In this embodiment, in addition to the aforementioned benzoic acid ester-based plasticizer, other plasticizers may be blended in the sealing material composition, as exemplified by phthalic acid ester-based plasticizers, fumaric acid ester-based plasticizers, sulfonic acid ester-based plasticizers, citric acid ester-based plasticizers, adipic acid ester-based plasticizer, or the like.

Moreover, in addition to each of the aforementioned ingredients, within a range such that the object of this embodiment is not impaired, the composition of this embodiment may include various types of additives as may be required. Such additives are exemplified by fillers, plasticizers, tackifier agents, pigments, dyes, antiaging agents, antioxidants, antistatic agents, flame retardants, tackifier resins, stabilizers, and dispersants. Each of the additives may be used in a suitable combination.

The filler can be an organic or inorganic filler of any form. The filler is exemplified by organic or inorganic fillers such as pyrophyllite clay, kaolin clay, calcined clay, silica sand, fumed silica, calcined silica, precipitated silica, pulverized silica, fused silica, diatomaceous earth, calcium carbonate, iron oxide, zinc oxide, titanium oxide, barium oxide, magnesium oxide, magnesium carbonate, zinc carbonate, carbon black or the like; as well as fatty acid-treated, resin acid-treated, fatty acid ester-treated, and fatty acid esterurethane compound-treated products of any of the above.

The plasticizer is exemplified by polypropylene glycol (B), diisononyl phthalate (DINP), dioctyl phthalate (DOP), dibutyl phthalate (DBP), dioctyl adipate, isodecyl succinate, diethylene glycol dibenzoate, pentaerythritol esters, butyl oleate, methyl acetyl ricinoleate, tricresyl phosphate, trioctyl phosphate, propylene glycol adipate polyester, butylene glycol adipate polyester, and phenyl ester alkyl sulfonate (e.g. MESAMOL produced by Bayer AG). It is possible to use an acrylic polymer having a number average molecular weight of from not less than 500 and not more than 5,000 produced by polymerization at a temperature of from not less than 150 and not more than 350° C. without using a chain transfer agent.

The tackifier agent is exemplified by silane coupling agents such as trimethoxyvinylsilane, γ-glycidoxypropyltrimethoxysilane, or the like. Such silane coupling agents are preferred for their excellent effect in improving adhesion to moist surfaces and due to the versatility of such compounds.

The pigment may be an inorganic pigment or an organic pigment. The utilized pigment is exemplified by inorganic pigments such as carbon black, titanium oxide, zinc oxide, ultramarine pigment, colcothar, lithophone, lead, cadmium, iron, cobalt, aluminum, hydrochloride salts, and sulfuric acid salts, as well as organic pigments such as azo pigments, copper phthalocyanine pigment, or the like.

No particular limitation is placed on the dye, and any known dye may be used, as exemplified by black dyes, yellow dyes, red dyes, blue dyes, and brown dyes.

Specific examples of the antiaging agents include hindered phenol compounds and hindered amine compounds, and the like.

Examples of the antioxidants include butylhydroxytoluene (BHT), butylhydroxyanisole (BHA).

Examples of the antistatic agent include quaternary ammonium salts; hydrophilic compounds such as polyglycols, ethylene oxide derivatives, and the like.

Examples of the flame retardant include chloroalkyl phosphates, dimethyl-methyl phosphates, bromine-phosphorus compounds, ammonium polyphosphates, neopentyl bromide polyethers, brominated polyethers.

The tackifier resin is exemplified by terpene resins, phenolic resins, terpene-phenolic resins, rosin resins, xylene resins, epoxy resins, alkyl titanates, organic polyisocyanates, or the like.

The stabilizer is exemplified by fatty acid silyl esters, fatty acid amides trimethylsilyl compounds, or the like.

The dispersant has the property of causing dispersion of fine particles of a solid in a liquid. The dispersant is exemplified by sodium hexametaphosphate, sodium condensed naphthalene sulfonate, surfactants, or the like.

Although no particular limitation is placed on the method of production of the composition of this embodiment, the composition may be produced by a method such as sufficient kneading of each of the aforementioned ingredients using a mixing apparatus (e.g. roller, kneader, extruder, universal agitator, blender-mixer, or the like) under vacuum or inert gas atmosphere (e.g. nitrogen or the like) to cause uniform dispersion of the ingredients.

The obtained composition of this embodiment may be stored in a hermetically sealed container, and may be used to obtain a cured product at room temperature due to humidity in the air at the time of use.

In this manner, the composition of this embodiment is a secondary sealing material composition for multi-layered glass that includes a modified silicone-based polymer having an acrylic acid ester-based polymer as the main chain and a benzoic acid ester-based plasticizer. Due to the ability to increase uniformity of blending of the modified silicone-based polymer and the benzoic acid ester-based plasticizer, the composition of this embodiment is able to decrease moisture-induced lowering of modulus of the cured product obtained by curing the composition of this embodiment. That is to say, when a cured product of the composition including a conventionally used urethane-based prepolymer was used as a secondary sealing material for multi-layered glass, it was not possible to stably restrain the glass sheets, i.e. glass sheet movement occurred due to expansion and contraction of the glass and lowering of modulus due to the external environment such as heat, water, humidity or the like. Thus, the primary sealing material, which readily breaks due to movement of the glass sheets, was broken, external air and water entered through the gaps in the primary sealing material, and condensation occurred in the interior of the multi-layered glass. In contrast, the composition of this embodiment includes a modified silicone-based polymer having an acrylic acid ester-based polymer as the main chain and a benzoic acid ester-based plasticizer. Thus, the composition of this embodiment is able to decrease the lowering of the modulus due to the external environment such as heat, water, humidity or the like, and is thus able to have high durability. Thus, when the cured product of the composition of this embodiment is used as a secondary sealing material for multi-layered glass, it is possible to stably restrain the glass sheets even when the glass expands and contracts. Thus, breakage of the primary sealing material due to movement of the glass sheets may be suppressed. It is thus possible to suppress the occurrence of condensation in the interior of the multi-layered glass that results from external air and water entering through gaps in the primary sealing material.

### <Multi-Layered Glass>

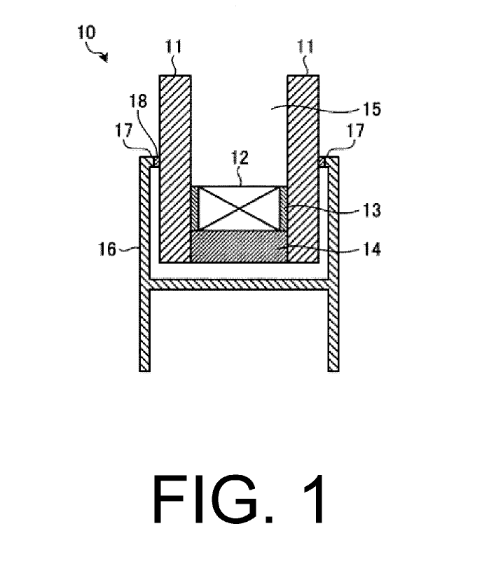

The multi-layered glass of this embodiment will be described below. The multi-layered glass of this embodiment uses the composition of this embodiment as the secondary sealing material. FIG. 1 is a cross-sectional view schematically illustrating an example of a structure of the multi-layered glass of this embodiment. As illustrated in FIG. 1, the multi-layered glass 10 according to this embodiment includes two glass sheets 11, a spacer 12, a primary sealing material 13, and a secondary sealing material 14. The two glass sheets 11 are disposed so as to oppose one another via the spacer 12 disposed therebetween. The gaps between the spacer 12 and the two glass sheets 11 are partially or entirely sealed by the primary sealing material 13. A hollow layer 15 is formed between the two glass sheets 11 due to sealing of the gaps between the spacer 12 and the two glass sheets 11 by the primary sealing material 13. The secondary sealing material 14 partially or entirely seals the void formed between the outer peripheral surface of the primary sealing material 13 and the spacer 12 at the side opposite the hollow layer 15, and the inner faces of the two glass sheets 11. The secondary sealing material 14 is obtained by filling the void by the composition of this embodiment and allowing the composition of this embodiment to cure. A drying agent (desiccant) may be present to the interior of the spacer 12.

The multi-layered glass 10 of this embodiment is mechanically fitted to a window flame 16 by glass fitting blocks 17 of the window sash (window frame) 16. Moreover, and elastic sealing agent 18 is arranged between the window frame 16 and the glass sheet 11. The elastic sealing agent 18 fixedly bonds the window frame 16 to the multi-layered glass 10 by friction. Simultaneously, the elastic sealing agent 18 provides good support for the individual glass sheets 11 of the multi-layered glass 10 by the window frame 16. Entry of water from the exterior is prevented by this elastic sealing agent 18.

No particular limitation is placed on the configuration, construction, or the like of the multi-layered glass 10 of this embodiment, as long as the composition of this embodiment is used as the secondary sealing material 14. For example, a combined spacer-sealing material may be used that is composed of a composition for integrating the spacer 12 and the primary sealing material 13. Moreover, an adhesive layer may be arranged between the glass sheet 11 and the primary sealing material 13.

Although two glass sheets 11 were provided for the multi-layered glass 10 of this embodiment, this embodiment is not limited thereto, and three or more glass sheets 11 may be provided, and the number of sheets may be determined appropriately as may be required.

A spacer generally used for multi-layered glass may be used as the spacer 12 in the multi-layered glass 10 of this embodiment. For example, a metallic spacer having a hollow structure may be used that has the hollow part packed with drying agent (desiccant), a plastic spacer, or the like. In the multi-layered glass 10 of this embodiment, no particular limitation is placed on the glass sheets 11, and for example, glass sheets may be used that are utilized for vehicles or as construction material. Specific examples include glass, float plate glass, template glass, heat reflecting glass, mesh-reinforced glass, heat absorbing glass, low emissivity glass (low-e glass), tempered glass, organic glass, or the like. No particular limitation is placed on thickness of the glass sheet 11, and this thickness may be a certain suitable value.

In the multi-layered glass 10 of this embodiment, no particular limitation is placed on the material of the primary sealing material 13, and butyl rubber-based hot melt material, low moisture permeability material, or the like may be used. From the standpoint of low gas permeability, the material of the primary sealing material 13 is preferably a butyl rubber-based sealing material.

No particular limitation is placed on the method of production of the multi-layered glass 10 of this embodiment. For example, the multi-layered glass 10 of this embodiment may be produced by placing the spacer 12 between two mechanically-fixed parallel glass sheets 11, gluing the spacer 12 in place by extruding the primary sealing material 13 using a nozzle or the like connected to an extruder, and thereafter providing the secondary sealing material 14 by extrusion of the composition of this embodiment using an extruder. Moreover, the glass sheet 11 and the spacer 12, as may be required, may be treated by coating with a primer or adhesive.

The primer and adhesive may be applied by manual operation using an applicator or the like, or alternatively, may be applied automatically by using an extruder to extrude the primer or adhesive. An extruder may be used to directly extrude the composition of this embodiment and adhesive into the peripheral edge of the glass sheets 11 so as to provide adhesive between the glass sheets 11 and the spacer 12 and also between the primary sealing material 13 and the secondary sealing material 14.

Since the composition of this embodiment is used as the secondary sealing material 14 of the multi-layered glass 10 of this embodiment, the secondary sealing material 14 may have high durability. Thus, good adhesion may be maintained between the glass sheets 11 and the secondary sealing material 14, and it becomes possible to stably restrain the glass sheets 11. It is thus possible to suppress breakage of the primary sealing material 13 due to movement of the glass sheets 11. It thus becomes possible to suppress breakage of the primary sealing material 13, entry of external air or water through gaps in the primary sealing material 13, and the occurrence of condensation in the interior of the multi-layered glass 10.

The composition of this embodiment is used with advantage in the above manner as a sealing material for multi-layered glass due to the composition of this embodiment having excellent characteristics as described above. However, the applications of the composition of this embodiment are not particularly limited, and for example, the composition of this embodiment is preferably used as a sealing material for civil engineering construction, concrete, automobiles, wood, metal, glass, plastic, or the like. The compositions of this embodiment are preferably used as various types of sealing materials, elastic adhesives, various types of sealants, potting agents, coating agents, and lining materials. The composition of this embodiment is preferably used as a structural adhesive in concrete or mortar for joints of metallic or ceramic type siding material, joints of concrete walls, tile joints, or the like, an injection agent for cracks, or the like.

The composition of this embodiment was explained above in the case of a one-liquid type secondary sealing material composition for multi-layered glass. Taking into account the applications, processability, or the like of the composition of this embodiment, the composition of this embodiment may also be a two liquid-type secondary sealing material composition for multi-layered glass. That is to say, the sealing material composition may be any secondary sealing material composition for multi-layered glass having a modified silicone-based polymer having an acrylic acid ester-based polymer as the main chain, a main agent including a benzoic acid ester-based plasticizer and a curing product including a benzoic acid ester-based plasticizer.

No particular limitation is placed on the method of production of the main agent and the curing agent. The aforementioned modified silicone-based polymer and benzoic acid ester-based plasticizer, various types of additives to be added as may be required, or the like may each be blended by the aforementioned method. Prior to use, the two liquid-type sealing material composition is blended by the normal method by mixing the main agent and the curing agent. The two liquid-type sealing material composition may be moisture-curable, reaction-curable, or heat-curable.

### EXAMPLES

The composition of this embodiment is described in detail below using Working Examples, but this embodiment is not limited to these Working Examples.

### Working Examples 1 to 4, Comparative Examples 1 to 5

The curing agent and main agent of the compositions (parts by mass) indicated in Table 1 were each prepared using the respective ingredients of the below listed Table 1. A mixer was used to blend each main agent and curing agent indicated in Table 1 to obtain a two liquid-type secondary sealing material composition for multi-layered glass and produce a sealing material. The added amounts (parts by mass) of each ingredient in the Working Examples and Comparative Examples are shown in Table 1.

Breaking strength for each of the sealing materials obtained in the aforementioned manner was evaluated by the below described method. The results are shown in Table 1.

### (Breaking Strength)

Each of the sealing materials obtained in the aforementioned manner was subjected to testing based on JIS A 1439. After initial curing (20° C. for 7 days+50° C. for 7 days), maximum tensile stress (N/mm²) was measured. After further immersion in hot water (90° C. for 14 days), maximum tensile stress (N/mm²) was measured. Using a double-shape (H-shape) test body (H-shape test body) loaded with the sealing material between two glass sheets, evaluation for breaking strength was carried out based on a tensile adhesion test. The retention rate of maximum tensile stress after immersion in hot water was calculated based on the Formula (1) below. The term “initial curing” indicates that the H-shape test body was left for 7 days at 25° C. and thereafter it was left for 7 days at 50° C. Moreover, a separate H-shape test body, after the initial curing, was immersed for 14 days in hot water at 90° C., and then maximum tensile stress was measured in the same manner as above. The results of measurement of retention rate of maximum tensile stress after immersion in hot water are shown in Table 1. When retention rate was greater than or equal to 70 percent, breaking strength was determined to be good. Retention rate (%)=(maximum tensile stress of test body after immersion in hot water)/(maximum tensile stress of the test body after initial curing)×100 . . . (1) Determination Criteria

“o”: Breaking strength was good.
“x”: Breaking strength was poor.

TABLE 1

| | | | Working | Working | Working | Working |
|---|---|---|---|---|---|---|
| | | | Example | Example | Example | Example |
| | | | 1 | 2 | 3 | 4 |
| Main | Polymer | Acrylic | 100 | 100 | 100 | 100 |
| agent | A | acid ester- | | | | |
| | | based, | | | | |
| | | modified | | | | |
| | | silicone- | | | | |
| | | based | | | | |
| | | polymer | | | | |
| | Polymer | PPG-based, | | | | |
| | B | modified | | | | |
| | | silicone- | | | | |
| | | based | | | | |
| | | polymer | | | | |
| | Polymer | Polysulfide- | | | | |
| | C | based | | | | |
| | | polymer | | | | |
| | Plasticizer | Benzoic | 70 | 80 | 130 | 12 |
| | 1 | acid ester- | | | | |
| | | based | | | | |
| | Plasticizer | Phthalic | | | | |
| | 2 | acid ester- | | | | |
| | | based | | | | |
| | Plasticizer | Adipic | | | | |
| | 3 | acid-based | | | | |
| | | polyester | | | | |
| | Calcium carbonate 1 | | 120 | 120 | 120 | 120 |
| | Calcium carbonate 2 | | 80 | 80 | 80 | 80 |
| | Silica | | | | | |
| | Silane coupling agent | | 0.5 | 0.5 | 0.5 | 0.5 |
| Curing | Curing | Tin octylate | 3 | 3 | 3 | 3 |
| agent | catalyst | | | | | |
| | Plasticizer | Benzoic | 5 | 5 | 5 | 5 |
| | 1 | acid ester- | | | | |
| | | based | | | | |
| | Plasticizer | Phthalic | | | | |
| | 2 | acid ester- | | | | |
| | | based | | | | |
| | Plasticizer | Adipic | | | | |
| | 3 | acid-based | | | | |
| | | polyester | | | | |

| | Carbon black | 10 | 10 | 10 | 10 |
|---|---|---|---|---|---|
| (Total amount (parts by mass)) | | 388.5 | 398.5 | 448.5 | 330.5 |
| Content of plasticizer (mass %) | | 19.3 | 21.3 | 30.1 | 5.1 |
| Breaking | Retention rate (%) [after | 74.3 | 80.8 | 81.9 | 73.5 |
| strength | 14 days immersion in | | | | |
| | 90° C. hot water/initial | | | | |
| | curing] | | | | |

| | | | | |
|---|---|---|---|---|
| Evaluation | ∘ | ∘ | ∘ | ∘ |

| | | | Comparative | Comparative | Comparative |
|---|---|---|---|---|---|
| | | | Example 1 | Example 2 | Example 3 |
| Main | Polymer | Acrylic | 100 | 100 | |
| agent | A | acid ester- | | | |
| | | based, | | | |
| | | modified | | | |
| | | silicone- | | | |
| | | based | | | |
| | | polymer | | | |
| | Polymer | PPG-based, | | | 100 |
| | B | modified | | | |
| | | silicone- | | | |
| | | based | | | |
| | | polymer | | | |
| | Polymer | Polysulfide- | | | |
| | C | based | | | |
| | | polymer | | | |
| | Plasticizer | Benzoic | | | 70 |
| | 1 | acid ester- | | | |
| | | based | | | |
| | Plasticizer | Phthalic | 70 | | |
| | 2 | acid ester- | | | |
| | | based | | | |
| | Plasticizer | Adipic | | 70 | |
| | 3 | acid-based | | | |
| | | polyester | | | |
| | Calcium carbonate 1 | | 120 | 120 | 120 |
| | Calcium carbonate 2 | | 80 | 80 | 80 |
| | Silica | | | | |
| | Silane coupling agent | | 0.5 | 0.5 | 0.5 |
| Curing | Curing | Tin octylate | 3 | 3 | 3 |
| agent | catalyst | | | | |
| | Plasticizer | Benzoic | | | 5 |
| | 1 | acid ester- | | | |
| | | based | | | |
| | Plasticizer | Phthalic | 5 | | |
| | 2 | acid ester- | | | |
| | | based | | | |
| | Plasticizer | Adipic | | 5 | |
| | 3 | acid-based | | | |
| | | polyester | | | |

| | Carbon black | 10 | 10 | 10 |
|---|---|---|---|---|
| (Total amount (parts by mass)) | | 388.5 | 388.5 | 388.5 |
| Content of plasticizer (mass %) | | 19.3 | 19.3 | 19.3 |
| Breaking | Retention rate (%) [after | 61.4 | 62.4 | 36.7 |
| strength | 14 days immersion in | | | |
| | 90° C. hot water/initial | | | |
| | curing] | | | |

| | | | |
|---|---|---|---|
| Evaluation | x | x | x |

| | | | Comparative | Comparative |
|---|---|---|---|---|
| | | | Example 4 | Example 5 |
| Main | Polymer | Acrylic | | |
| agent | A | acid ester- | | |
| | | based, | | |
| | | modified | | |
| | | silicone- | | |
| | | based | | |
| | | polymer | | |
| | Polymer | PPG-based, | 100 | |
| | B | modified | | |
| | | silicone- | | |
| | | based | | |
| | | polymer | | |
| | Polymer | Polysulfide- | | 100 |
| | C | based | | |
| | | polymer | | |
| | Plasticizer | Benzoic | | 70 |
| | 1 | acid ester- | | |
| | | based | | |
| | Plasticizer | Phthalic | 70 | |
| | 2 | acid ester- | | |
| | | based | | |
| | Plasticizer | Adipic | | |
| | 3 | acid-based | | |
| | | polyester | | |
| | Calcium carbonate 1 | | 120 | 120 |
| | Calcium carbonate 2 | | 80 | 80 |
| | Silica | | | |
| | Silane coupling agent | | 0.5 | 0.5 |
| Curing | Curing | Tin octylate | 3 | 3 |
| agent | catalyst | | | |
| | Plasticizer | Benzoic | | 5 |
| | 1 | acid ester- | | |
| | | based | | |
| | Plasticizer | Phthalic | 5 | |
| | 2 | acid ester- | | |
| | | based | | |
| | Plasticizer | Adipic | | |
| | 3 | acid-based | | |
| | | polyester | | |

| | Carbon black | 10 | 10 |
|---|---|---|---|
| (Total amount (parts by mass)) | | 388.5 | 388.5 |
| Content of plasticizer (mass %) | | 19.3 | 19.3 |
| Breaking | Retention rate (%) [after | 35.5 | 50.3 |
| strength | 14 days immersion in | | |
| | 90° C. hot water/initial | | |
| | curing] | | |

| | | |
|---|---|---|
| Evaluation | x | x |

The components shown in Table 1 are as follows.
Polymer A: Acrylic acid ester-based, modified silicone-based polymer, produced by Kaneka Corporation
Polymer B: PPG-based, modified silicone-based polymer, produced by Kaneka Corporation
Polymer C: Polymer including polysulfide-based polymer, produced by Toray Fine Chemicals Co., Ltd.
Plasticizer 1: Benzoic acid ester-based plasticizer, Benzoflex 9-88, produced by CBC Co., Ltd.
Plasticizer 2: Phthalic acid ester-based plasticizer (DINP, New Japan Chemical Co., Ltd.)
Plasticizer 3: Adipic acid-based polyester, DINA, produced by J-PLUS Co., Ltd.
Calcium carbonate 1: Hakuenka CCR, produced by Shiraishi Kogyo Kaisha, Ltd.
Calcium carbonate 2: Super S, produced by Maruo Calcium Co., Ltd.
Curing catalyst: Tin octylate
Carbon black: Product name “MA600,” produced by Mitsubishi Chemical Corp.

As shown in Table 1, the retention rate after immersion in hot water was found to have been at least 70 percent for each of the sealing materials of Working Examples 1 to 4. Thus, the sealing materials of Working Examples 1 to 4 may be said to have uniform blending of the main agent and the curing agent, and the humidity-induced lowering of modulus may be said to be minimal. This is thought to be the result of the benzoic acid ester-based plasticizer having the effect of preventing the lowering of elastic modulus that results from hot water entering the interior of the sealing material. On the other hand, retention rate after hot water immersion was found to be less than or equal to 70 percent for each of the sealing materials of Comparative Examples 1 to 5. Thus, the sealing materials of Comparative Examples 1 to 5 may be said to not sufficiently suppress the hot water-induced lowering of modulus. Lowering of breaking strength after immersion in hot water means that elastic modulus of the sealing material declines, the sealing material becomes soft, and the force restraining the glass sheet becomes weakened to that degree.

Therefore, by including the benzoic acid ester-based plasticizer in the modified silicone-based polymer (i.e. acrylic acid ester-based polymer), it is possible to decrease the humidity-induced lowering of modulus. Due to the ability to suppress the lowering of breaking strength that occurs after immersion in hot water, it is possible to suppress lowering of elastic modulus of the sealing material, and softening of the sealing material may be suppressed. It is thus possible to suppress the weakening of the force restraining the glass sheets. Therefore, due to the cured product of the composition of this embodiment having excellent durability against hot water, it was determined to be possible to use the cured product of the composition of this embodiment with advantage as a sealing material for multi-layered glass.

What is claimed is:

1. A secondary sealing material composition for multi-layered glass comprising:
a modified silicone-based polymer having an acrylic acid ester-based polymer as a main chain; and
a benzoic acid ester-based plasticizer.

2. The secondary sealing material composition for multi-layered glass according to claim 1, wherein content of the benzoic acid ester-based plasticizer in the composition is greater than or equal to 5 mass % and less than or equal to 30 mass %.

3. A multi-layered glass using as a secondary sealing material the secondary sealing material composition for multi-layered glass according to claim 2.

4. A multi-layered glass using as a secondary sealing material the secondary sealing material composition for multi-layered glass according to claim 1.

5. The secondary composition of claim 1, wherein the modified silicone-based polymer has a number average molecular weight of from 1,000 to 30,000.

6. The secondary composition of claim 1, wherein the modified silicone-based polymer has a number average molecular weight of from 3,000 to 15,000.

7. The secondary sealing material composition for multi-layered glass according to claim 1, wherein content of the benzoic acid ester-based plasticizer in the composition is greater than or equal to 15 mass % and less than or equal to 25 mass %.

8. The secondary sealing material composition for multi-layered glass according to claim 1, wherein content of the benzoic acid ester-based plasticizer in the composition is greater than or equal to 19 mass % and less than or equal to 22 mass %.
